(19) United States
(12) Patent Application Publication
(10) Pub. No.: US 2018/0316201 A1
(43) Pub. Date: Nov. 1, 2018

(54) PORTABLE POWER STRIP

(71) Applicant: Halo International Sezc Ltd., Georgetown (KY)

(72) Inventors: Garold C. Miller, Hartford, CT (US); Nathan Daniel Weinstein, Hartford, CT (US)

(21) Appl. No.: 15/878,632

(22) Filed: Jan. 24, 2018

Related U.S. Application Data
(60) Provisional application No. 62/450,243, filed on Jan. 25, 2017.

(51) Int. Cl. H02J 7/00; H02J 7/02; H01R 27/02

(52) U.S. Cl. CPC H02J 7/0026; H01R 27/02; H02J 7/027; H02J 7/0045

(57) ABSTRACT

A portable power strip is provided for charging one or more electronic devices using both DC and AC power output connection ports. The portable power strip may include a housing having an internal rechargeable battery unit for connecting to and recharging electronic devices, as necessary, at least one power input connector interface for recharging the internal battery unit from an external power source, and AC and DC power output connection ports for connecting the power charger with electronic devices, as necessary. The power strip further includes internal circuitry providing surge protection.

### CROSS-REFERENCE TO RELATED APPLICATIONS

This application claims the benefit of U.S. Provisional Patent Application No. 62/450,243, filed Jan. 25, 2017, which is incorporated herein by reference in its entirety.

### FIELD OF INVENTION

The present invention generally relates to power chargers for laptops and electronic devices, and more particularly relates to a portable power strip having an internal rechargeable battery, an AC input connection, and DC and AC output power ports, as well as other features that improve upon the use and functionality of a power strip.

### DISCUSSION OF ART

Present day consumers typically own several electronic devices specifically designed for portability and on-the-go use, including, for example, a laptop, a mobile phone or smart phone, a portable music player like an iPod® or an MP3 player, a tablet, a portable gaming unit, a camera, and the like. Each of these devices requires frequent recharging, or in the case of personal laptops, preferably are plugged into a power source for the most efficient use of the device. Such electronic devices typically utilize a cable for connecting the device to a power source, such as a wall outlet, a car charger, an airplane charger, or another computer. However, a separate cable is usually required for each power source. Moreover, different electronic devices often utilize different connection ports and interfaces such that a single charging cable is not compatible with multiple devices. Accordingly, a tech-savvy consumer, with several electronic devices, will usually have multiple charging cables to keep track of. Even then, the consumer may be without sufficient power to recharge a phone due to bad weather or a power outage, or may not always be in a place where a power source is readily available, or even if so, may not have the appropriate cable or adapter available to use with a particular power source.

With traditional power sources, such as those noted above, it is often difficult to charge multiple devices at the same time, especially where each device requires a separate charging cable. For example, a car charger port may only handle a single cable at a time. Adaptor devices are available on the market for connecting multiple devices to a power source at the same time—for example, a two-to-one or three-to-one car charger splitter. However, such adapters are often only compatible with certain interfaces. Moreover, such adapters are separate from portable power sources and tend to be bulky.

Similarly, connection interface attachments are also available for adapting a charging cable for use with a variety of devices for recharging from a power source, each requiring a different interface connection. However, such attachments are usually separate small pieces, and therefore difficult to keep track of when not in use. Further, use of such attachments does not solve the problem presented by the need to charge multiple devices at the same time, from the same power source, as oftentimes, only one attachment can be used with a charging cable at a time.

Power strips are common devices for plugging in multiple devices to a single power source. Such power strips usually provide surge protection to protect the devices should the power go out or if there is a power surge. However, typical power strips are designed to stayed plugged into an external power source—such as an AC wall socket—and typically do not and cannot continue to provide power once the power goes out. As a result, common power strips cannot also be used as an alternate portable power source.

Portable power chargers exist that permit recharging of electronic devices when a standard power source is not readily available. For example, portable power chargers are illustrated and described in co-pending U.S. application Ser. No. 13/682,985, filed Nov. 21, 2012, which shares common inventors with the present application and which is incorporated herein by reference. Some existing power charger devices usually cannot charge multiple devices at the same time, either due to limited capacity or connectivity options. Even if multiple devices may be attached to the power charger at the same time, the charger may prioritize how the devices are recharged—i.e., it will charge one device first and then the second, and so on. However, this approach takes a long time to recharge all devices and risks not having sufficient charge remaining in the charger for fully charging the second device.

Further, some portable charger devices will not permit recharging from the charger when the charger is itself being recharged or connected to an external power source. Such devices require the charger unit to be disconnected from a power source before a charge will be passed on to a device connected to the charger, or require the charger unit to be fully charged first before any device connected to the charger unit can then be recharged.

Additionally, such portable charger devices typically require a dedicated input port for recharging the internal battery and a separate output port dedicated for recharging electrical devices from the internal battery. More particularly, such charging devices often require multiple output ports for recharging multiple electronic devices at the same time. The addition of extra charging ports compromises the size and design of the charger unit, for example, a unit with a dedicated input port and two or more output ports would need to be larger than a charger unit with just a single port due to the need to properly arrange the electronics for operation of the charger as desired.

Additionally, such portable power chargers do not provide surge protection if the charger is connected to an external power source and power is being provided to electronic devices through the portable power charger.

In view of the foregoing, there is a need for a portable power strip that can be used to charge a variety of electronic devices, both mobile and stationary, including but not limited to laptops, smart phones, mobile phones, data tablets, music players, cameras, camcorders, gaming units, e-books, Bluetooth® headsets and earpieces, GPS devices, and the like, either individually or collectively in various combinations, both when connected to an external power source or as a portable power charger. Additionally, there is a need for such a power strip that is portable—namely, can be used as a power charger and surge protector even when it is not plugged into a power source—has a compact size, and is easy to use in various conditions and locations to charge one or more electronic devices simultaneously, or recharge the internal battery of the power strip unit for future on-the-go use, including but not limited to in a house or office, a car or an airplane. Still further, there is a need for a power strip having both DC connection ports and AC connection ports, as well as an internal rechargeable battery unit and an AC and/or DC power input connection means. Still further, there is a need for a power strip that provides adequate surge protection, and that can recharge the internal battery from an external power source (either from an AC power source or a DC power source) at the same time as electronic devices connected to the power strip. Still further, there is a need for a power strip in a compact size that has increased functionality for a user requiring a portable source of power. Accordingly, it is a general object of the present invention to provide a portable power strip that improves upon conventional power strips and portable power chargers currently on the market and that overcomes the problems and drawbacks associated with such prior art devices.

### SUMMARY OF THE INVENTION

In accordance with the present invention, a portable power strip is provided for charging one or more electronic devices using both DC and AC power output connection ports. In general, a portable power strip in accordance with the present invention may comprise a housing having an internal rechargeable battery unit for connecting to and recharging electronic devices, as necessary, at least one power input connector interface for recharging the internal battery unit from an external power source, and AC and DC power output connection ports for connecting the power strip with electronic devices, as necessary. The power strip further includes internal circuitry providing surge protection for any device connected thereto. Preferred embodiments of such circuitry further provides smart charging functionality for optimizing efficient charging of devices connected to the power strip, especially when multiple devices are connected to the strip at the same time.

Additionally, the power strip includes multiple DC connection ports, such as USB ports, and multiple AC connection ports, such as AC plug sockets. The power strip includes an internal rechargeable battery unit, but also an AC power cord for connection to an AC wall socket. The cord is preferably detachable, so it is not necessary when the power strip is used in portable mode. The power strip may further be connected to an external power source and one or more electronic device at the same time without affecting operation of the power strip to receive a charge from the external power source or supply a charge to the electronic devices.

The portable power strip can be provided with multiple and various power output and input interfaces to connect with various electronic devices and power sources—both AC and DC—including U.S. and foreign wall sockets of varying designs, a car charger socket, an airline charger socket, and USB micro-USB, mini-USB and pin connector interfaces.

In another aspect of the present invention, a power indicator or interface is provided on the power strip housing to indicate the power capacity level of the internal rechargeable battery unit. Another indicator can be used to indicate when power goes out and indicate further that the power strip has automatically switched into portable power mode whereby a charge is being provided from the internal battery unit of the power strip. The power interface can comprise a light or series of lights, a digital readout, or other known forms of indicating power level of a battery or existence of a power charge. Additional indicator means can be utilized in the present invention for various functionalities, including but not limited to indicating that a charge is being provided to an electronic device, either from a standard power source or the internal battery unit of the portable power strip, or indicating the power level in an electronic device attached to the power strip via the power output connection ports.

These and other objects, features and advantages of the present invention will become apparent in light of the detailed description of embodiments thereof, as illustrated in the accompanying drawings.

### BRIEF DESCRIPTION OF THE DRAWINGS

FIG. 1 shows a front perspective view of a portable power strip in accordance with a first embodiment of the present invention.

FIG. 2 shows a cut-away perspective view of the portable power strip of FIG. 1.

FIG. 3A shows a top view of the portable power strip of FIG. 1.

FIG. 3B shows a right front perspective view of the portable power strip of FIG. 1.

FIG. 3C shows a back perspective view of the portable power strip of FIG. 1 and further illustrates a power cord connected to the portable power strip.

FIG. 3D shows a front perspective view of the portable power strip of FIG. 1 with the power cord in a coiled configuration.

FIG. 4 shows a front perspective view of a portable power strip of FIG. 1 with a rotatable AC plug socket.

FIG. 5 shows a partial cut-away front perspective view of a portable power strip in accordance with a second embodiment of the present invention with a power indicator means.

FIG. 6 shows a top view of the portable power strip of FIG. 5 with a different power indicator means.

FIG. 7 shows a front perspective view of a portable power strip in accordance with a third embodiment of the present invention.

FIG. 8 shows an exemplary charging chart illustrating various battery voltage thresholds for triggering different charging functions utilized in portable power strips of FIGS. 1-7.

FIG. 9 shows an exemplary surge protection circuit utilized in portable power strips of FIGS. 1-7.

### DETAILED DESCRIPTION OF THE DRAWINGS

In the figures, like reference numerals refer to like features of various embodiments of portable power strips shown and described in accordance with the present application. Accordingly, although certain descriptions may refer only to certain figures and reference numerals, it should be understood that such descriptions might be equally applicable to like reference numerals in other figures.

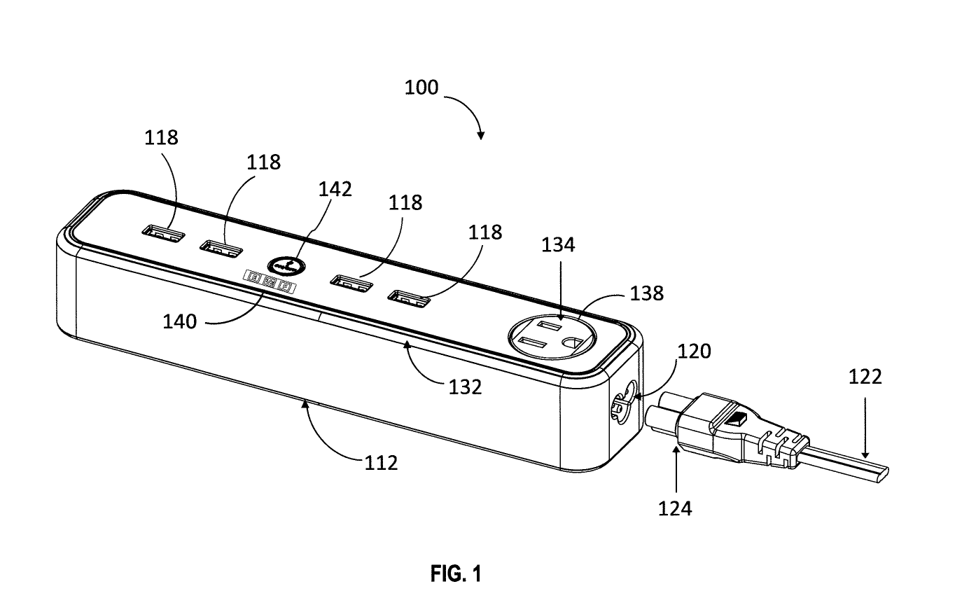

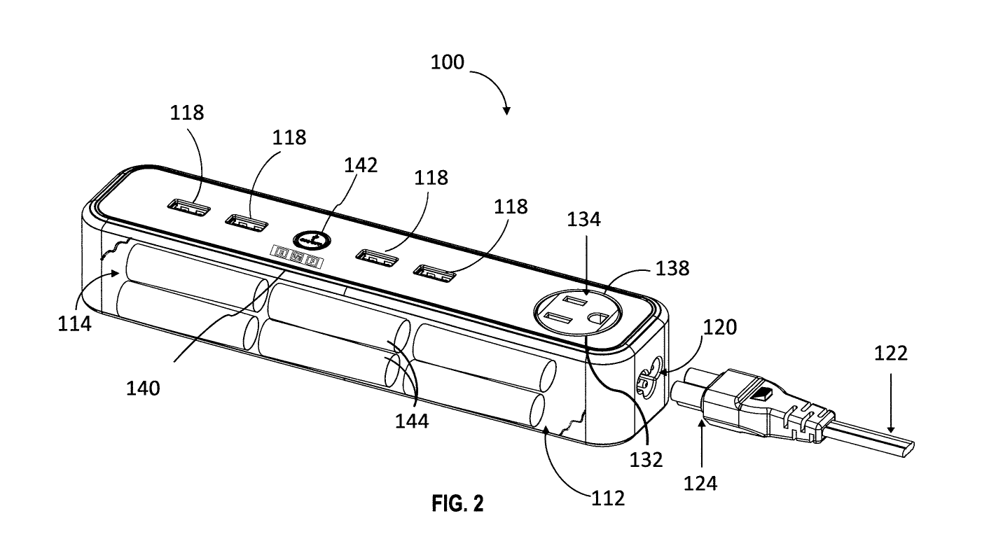

A portable power strip in accordance with a first embodiment of the present invention is shown in FIGS. 1-4 and generally designated as reference numeral 100. As illustrated, the power strip 100 comprises a housing 112 with a generally rectangular longitudinal shape having a rechargeable internal battery 114 (shown in FIG. 2) for recharging one or more electronic devices via at least one power connection output port provided on the housing 112. The housing 112 is further provided with at least one power input interface, described in more detail below, for recharging the internal battery 114 or for providing direct power to the power connection output ports when the power strip is connected to an external power source.

Referring to FIG. 1, multiple DC connection ports 118 are provided on a side face of the housing 112. Additionally, a power input connection, such as an AC power input port 120, is provided on an end face of the housing 112. The DC connection ports 118 may be used to supply power to various electronic devices from the rechargeable internal battery 114. In some embodiments, power may be directly supplied to the various electronic devices from an external power source, such as an AC wall socket, using the power strip 100 as an intermediary when the power strip is connected to the external power source via the AC power input port 120. In this regard, the power strip 100 acts both as a power charger and as a power adapter for recharging electronic devices. In such embodiments, the power strip 100 can simultaneously recharge the internal battery 114 while providing power to at least one DC connection port 118. In this regard, the internal battery 114 can be charged and ready in case of a power outage.

In some embodiments, the DC connection ports 118 are used by the portable power strip 100 as both an input and an output. In such embodiments, a two-way charging port 118 can operate as either a power input (for providing an electrical charge from an external power source for recharging the internal battery unit when the portable power strip 100 is connected to the external power source) or a power output (for charging the internal batteries of other electronic devices from the rechargeable battery unit), or both.

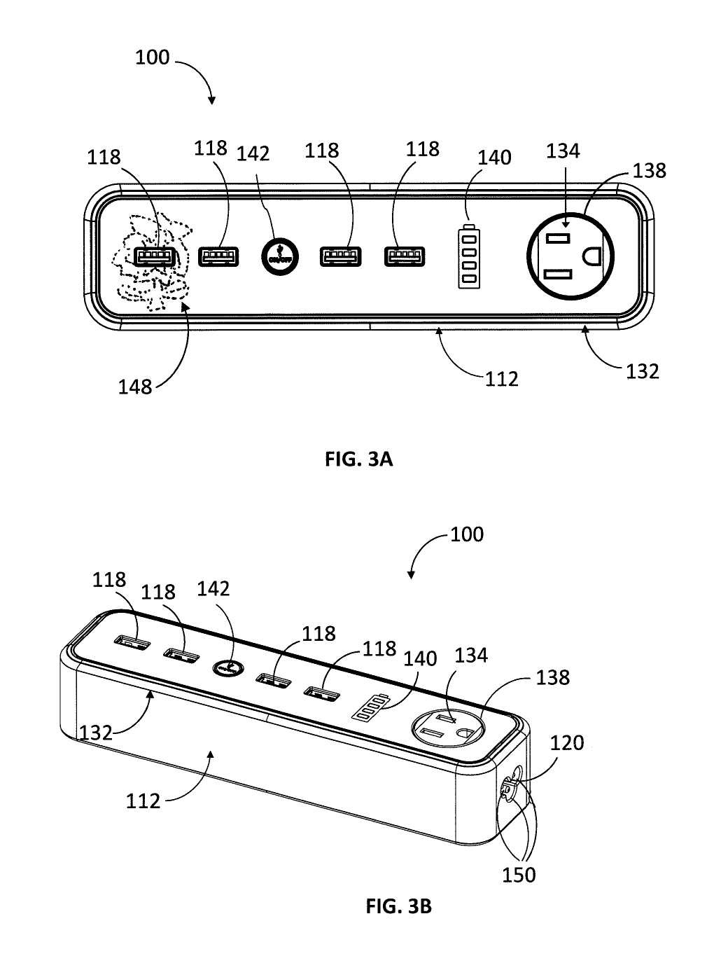

The AC power input port 120 is configured to receive an AC power cord 122 and, in embodiments, is a three-pronged connection interface, as shown in FIG. 3B. As illustrated in FIG. 1, the AC power cord 122 has a proximal end 124 for connecting to the AC power input port 120 and a distal end 128 for connecting to an external power source. Various connection interfaces, such as a female input connection interface 129 (shown in FIG. 3C) may be disposed on the proximal end 124 of the AC power cord 122, while other connection interfaces, such as an AC wall plug interface 130 (shown in FIG. 1), may be disposed on the distal end 128 of the AC power cord 122.

The AC power cord 122 is preferably detachable from the power strip 100 so that the power strip can be used as a portable power charger. When detached, a first indicator light 132 extending around a top perimeter of the housing 112, may illuminate to signal that the power strip 100 is in a portable mode. The first indicator light 132 may also signal that the external power source is no longer supplying power, such as in the event of a power outage. Thus, in the event of a power outage, the illuminated first indicator light 132 can assist in locating the power strip 100 to provide power to recharge various electronic devices.

The first indicator light 132 may be a single LED or multiple LEDs extending around the perimeter of a side and/or end face of the housing 112. In some embodiments, such as illustrated in FIG. 2, the first indicator light 132 may extend around the perimeter of a side face and illuminate the various connection interfaces.

Referring back to FIG. 1, at least one AC connection output port, such as an AC plug socket 134, is provided on a side face of the housing 112 and is outlined by a second indicator light 138. The AC plug socket 134 may be used to supply power to extension cords, traditional-type power strips, or any other devices having an AC plug interface, from the rechargeable internal battery 114. In some embodiments, the power strip 100 can simultaneously recharge the internal battery 114 while providing power to the AC plug socket 134.

The second indicator light 138 outlining the AC plug socket 134, in some embodiments, is a rounded-edge square shape and illuminates in the same color, for example blue, as the first indicator light 132. In some embodiments, the second indicator light 138 illuminates as a different color than the first indicator light 132. The second indicator light 138 may be a single LED or multiple LEDs creating a perimeter around the AC plug socket 134. In the event of a power outage, the second indicator light 138 can illuminate to assist in locating the AC plug socket 134.

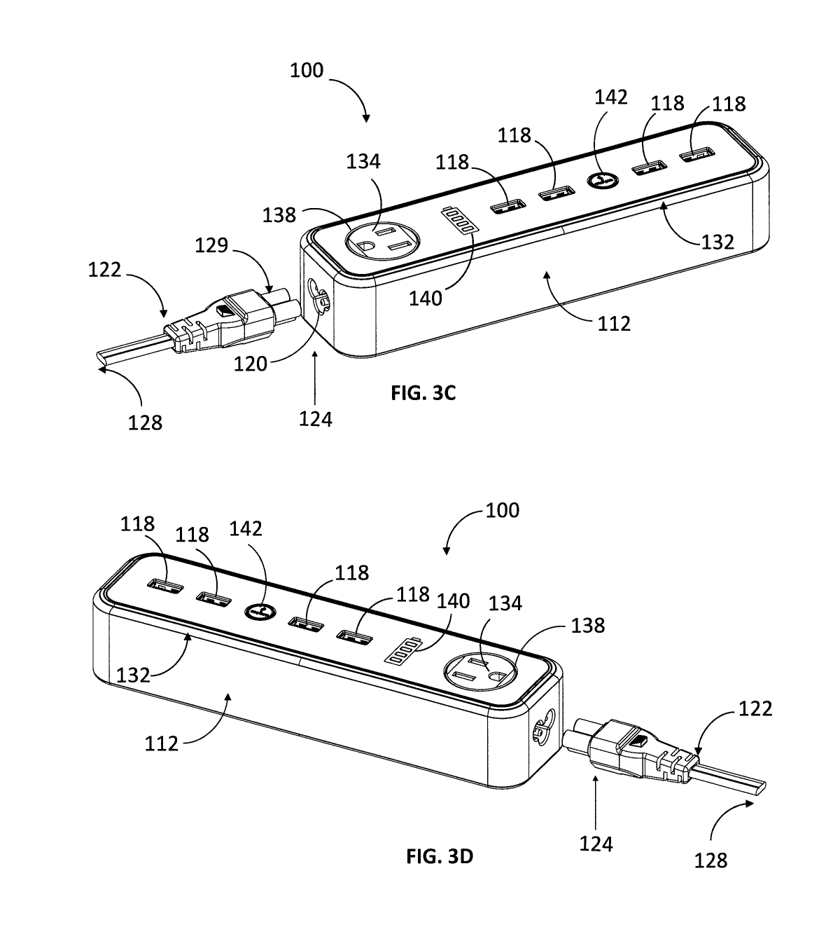

The second indicator light 138 may also be an oval or circular shape to accommodate a circular AC plug socket 134, as illustrated in FIG. 4, without departing from the spirit and principles of the present invention.

Referring back to FIG. 1, the housing 112 further includes power indicator means 140 for displaying the battery capacity and remaining charge of the internal battery 114. For example, in an embodiment of the present invention, the power indicator means 140 comprises a series of lights, but can include more or fewer lights without departing from the principles and spirit of the present invention. When the battery 114 is at full capacity or near full capacity, a “full light—designated by an “F” will be lit up. As battery power decreases, the lights will correspondingly adjust as the power is used. For example, when the battery 114 is approximately at half-charge, then an associated “½” light will be lit up. If there is no capacity left in the internal battery, a light corresponding to an “empty” indication—designated by an “E” will be lit up.

Also contemplated within the scope of the present disclosure is a power indicator means including five lights in series with designations of “E,” “¼,” “½,” “¾,” and “F” to represent the various stages of the battery 114 charge.

Still further, as shown in FIGS. 3A, 3B, 3C, 3D, 5, 6 and 7, the power indicator means 140 can be in the shape of a battery with four power indicator bars 141 which provide available charge information of the internal rechargeable battery 114 by some or all of the power indicator bars 141 illuminating. For example, one illuminated power indicator bar 141 indicates a charge of approximately 0%-25%, two illuminated power indicator bars 141 indicates a charge of approximately 26%-50%, three illuminated power indicator bars 141 indicates a charge of approximately 51%-75%, and four illuminated power bars 141 indicates 100% or a fully charged internal battery 114. In a similar manner, when the at least one electronic device 132 is being charged by the internal battery unit 114, the power indicator bars 141 may indicate the charge level of at least one connected electronic device.

As shown in FIG. 1, the housing 112 further includes an on-off power button 142 operatively connected to internal functional components and electrical circuitry discussed herein for operating the power strip 100. The on-off power button 142 may illuminate green while the portable power charger 100 is active. A user can manually turn off the power strip 100 to save battery capacity.

Referring to FIG. 2, a cut-away perspective view of the portable power strip 100 is shown. In some embodiments, the internal battery 114 comprises a series of battery cells 144, such as 3000 mAh cells, to power the various electronic devices connected to the power strip 100. In various embodiments, there can be six or nine battery cells 144 arranged, for example, in two rows or three rows, respectively, to provide a total of 18,000 or 24,000 mAh of power, respectively. Other amounts, configurations, and types of battery cells 144 can also be used without departing from the spirit and principles of the present invention.

Referring to FIGS. 3A, 3B, 3C and 3D, various views of the power strip of FIG. 1 are shown. Generally, the power indicator means 140 is in a battery-shape and arranged to run perpendicular to the length-wise direction of the portable power strip 100.

Referring to FIG. 3A, a top view of the power strip 100 is shown. In some embodiments, a side of the housing 112 may include a decorative skin 148, such as a floral pattern, extending over the DC connection ports 118 and/or AC power sockets 134, obfuscating and camouflaging the connection interfaces, and improving upon the aesthetic appearance of the housing 112.

Referring to FIG. 3B, a right front perspective view of the portable power strip 100 is shown. In some embodiments, multiple DC connection ports 118 are provided in a linear configuration and are distributed in two pairs on either side of the power button 142. In such a configuration, the DC connection ports 118 run parallel to a length-wise direction with the portable power strip 100.

The AC power input port 120, configured to receive an AC power cord 122, can be, for example, a clover shape having one or more prongs 150 extending therefrom. The one or more prongs 150 establish an electrical connection with the proximal end 124 of the AC power cord 122, as shown in FIG. 3C.

Referring to FIG. 3C, a back perspective view of the portable power strip 100 is shown with the female input connection interface 129 connected to the AC power input port 120.

Referring to FIG. 3D, a front perspective view of the portable power strip 100 is shown. In some embodiments, more DC connection ports 118 are provided on housing 112 than AC plug sockets 134. Such embodiments allow for greater charging of multiple electronic devices while keeping the size of housing 112 small.

Referring to FIG. 4, the circular AC plug socket 134 is disposed on a side face of the housing 112. The circular AC plug socket 134 can rotate 360 degrees, in both clock-wise and counter clock-wise directions, to accommodate a wide variety of AC plug interfaces. In some embodiments, the rounded-edge square shape AC plug socket can also rotate 360 degrees. The housing 112, further includes the indicator means 140, in the shape of a battery, running parallel in a length-wise direction with the portable power strip 100.

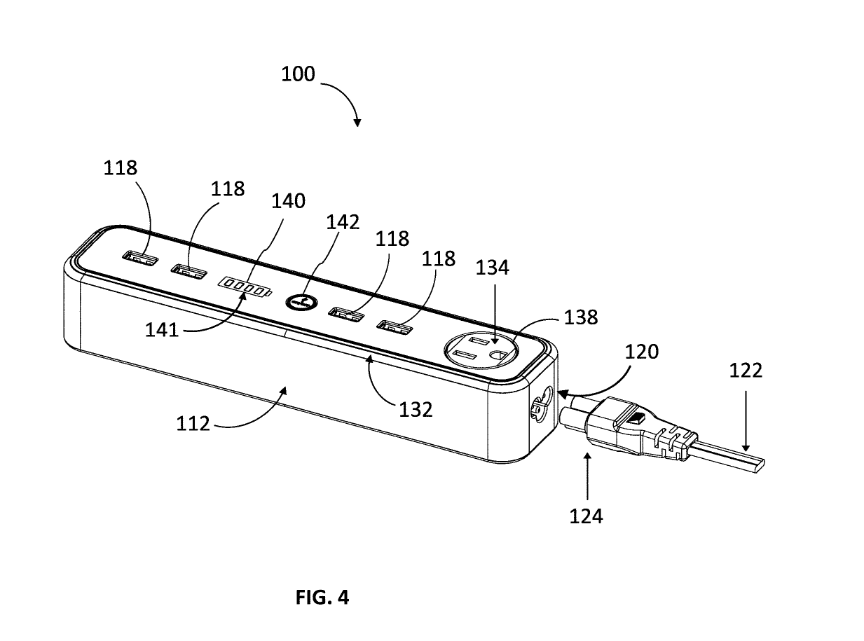

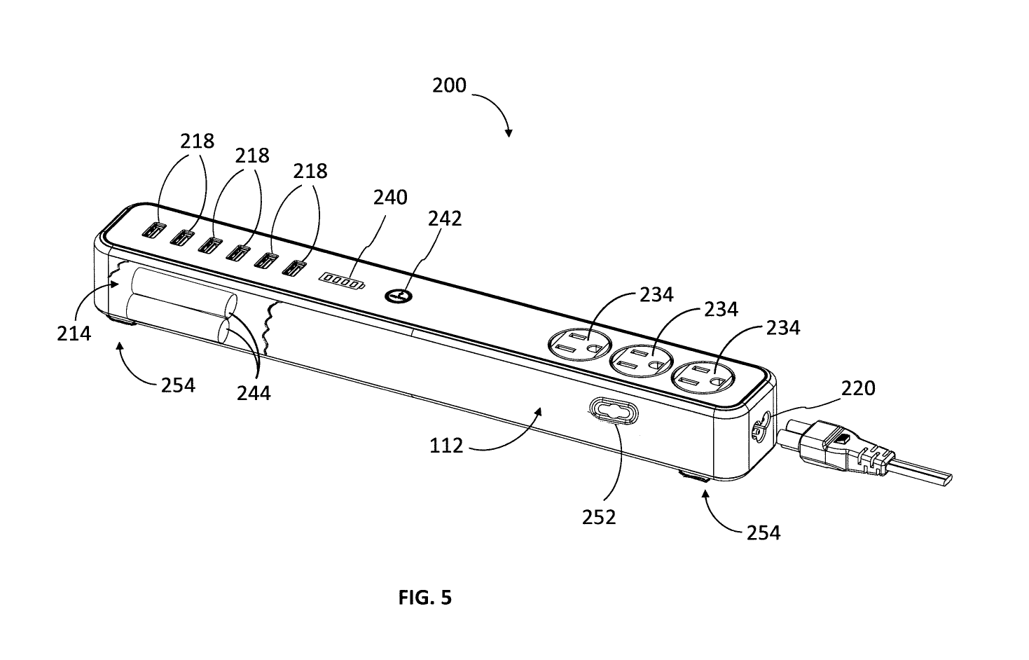

A portable power strip in accordance with a second embodiment of the present invention is shown in FIGS. 5-6 and generally designated as reference numeral 200. As illustrated in FIG. 5, the power strip 200 comprises a housing 212 with a generally rectangular shape having a rechargeable internal battery 214 for recharging one or more electronic devices via at least one DC connection port, such as a USB port 218, or at least one AC connection port, such as an AC plug socket 234 provided on the housing 212.

The internal battery 214 comprises a series of battery cells 244, such as 3000 mAh cells, to power the various electronic devices connected to the power strip 200. The battery cells 244 can be arranged as two rows of six battery cells 244 to provide a total of 36,000 mAh of power.

The USB ports 218 may be arranged to run perpendicular to the length-wise direction of the portable power strip 200 and used to supply power to various electronic devices from the rechargeable internal battery 214.

A series of AC plug sockets 234 are operatively connected to the internal battery 214 and may be used to supply provide to devices having an AC plug interface. As illustrated in FIGS. 5 and 6, there are six USB ports 218 and three AC plug sockets 234 arranged on a side face of the housing 212 and separated by power indicator means 240.

The power indicator means 240 is operatively connected to the internal battery 214, or, in some embodiments, a battery of a connected electronic device, and can comprise a light or series of lights, a digital readout, or other forms of indicating power level of a battery or existence of a power charge, as discussed herein. For example, the power indicator means 240 may be operatively connected to some or all of the six USB ports 218 to display the remaining charge of a connected electronic device. Likewise, the power indicator means 240 may be operatively connected to some or all of the three AC plug sockets 234 for displaying the remaining charge, if applicable, of a connected electronic device. Still further, as shown in FIG. 6, the power indicator means 240 can be in the shape of a battery with power indicator bars 241 which provide available charge information of the internal rechargeable battery 214 by some or all of the power indicator bars 241 illuminating.

Referring back to FIG. 5, the housing 212, in some embodiments, further includes a keyhole-mounting slot 252 disposed on a side face for mounting the power strip 200 to a wall or other vertical surface.

In some embodiments, anti-skid feet 254 for keeping the power strip 200 in place and slightly elevating the power strip 200 above a floor are disposed on a bottom surface of the housing 212.

The housing 212, in some embodiments, further includes a power input connecting interface, such as an AC power input port 220 configured to receive AC power from an external power source formed within an end face. As shown in FIG. 6, the AC power input port 220 can slightly extend from the general footprint of the portable power strip 200.

Further illustrated in FIG. 6, the housing 212 includes an on-off power button 242 operatively connected to internal functional components and electrical circuitry discussed herein for operating the power strip 200.

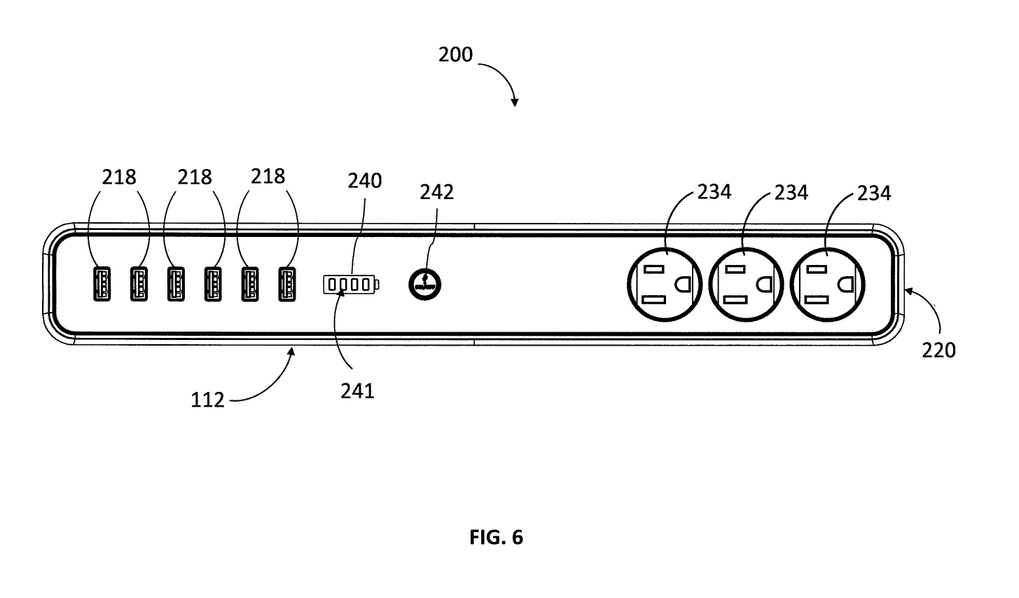

A portable power strip in accordance with a third embodiment of the present invention is shown in FIG. 7 and generally designated as reference numeral 300. As illustrated, the power strip 300 comprises a housing 312 with a generally cube shape having a rechargeable internal battery (not shown) for recharging one or more electronic devices via at least one DC connection port, such as a USB port 318, or at least one AC connection port, such as an AC plug socket 334 provided on the housing 312.

The USB port 318 may be a 5 V/2.4 A port that allows charging of multiple devices from the same USB port 318, such as, for example, by a splitter connector having a USB connection interface (for connecting with the USB port 318) and two or more electronic device connection interfaces (for connecting with two or more electronic devices).

The at least one AC plug socket 334 can rotate 360 degrees, in both clock-wise and counter clock-wise directions, to accommodate a wide variety of AC plug interfaces.

The housing 312 further includes power indicator means 340 in the shape of a battery with four power indicator bars 341 which provide available charge information of the internal rechargeable battery by some or all of the power indicator bars 341 illuminating in a green color. Such power indicator bars 341 may each be separate green LEDs.

The housing 312 further includes an on-off power button 342 operatively connected to internal functional components and electrical circuitry. Additionally, the portable power strip 300 may have an automatic “on” and automatic “off” feature, such that the portable power strip 300 turns on and provides power when at least one electronic device is connected to the power strip 300, and turns off when the at least one electronic device is fully charged. Additionally or alternatively, the power strip 300 may automatically turn off after the at least one electronic device is unplugged from the power strip 300 and after a defined period of time. For example, if an electronic device were unplugged from the power strip 300, after a ten second delay, the portable power strip 300, preferably in portable mode, would turn off.

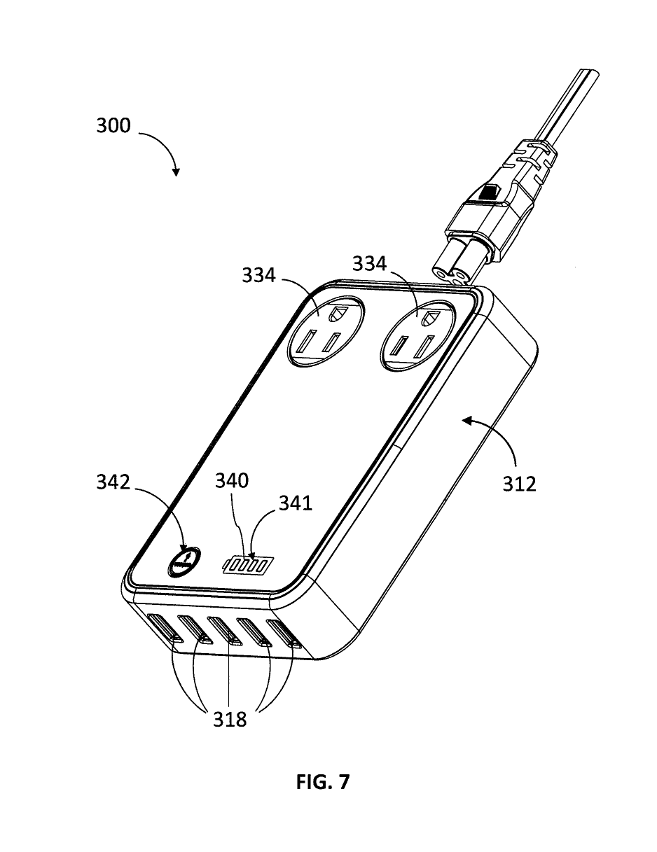

The portable power strip 100, 200, 300 in accordance with various embodiments of the present invention shown in FIGS. 1-7, generally, receives power from DC power sources, AC power sources, or both, and provides charging for one or more electronic devices using both DC and AC power connection ports. The portable power strip 100, 200, 300 comprises a controller, including a processing unit, configured to execute instructions and to carry out operations associated with the power strip 100, 200, 300. For example, the processing unit can keep track of the capacity level of an internal battery, store data or provide a conduit means by which data can be exchanged between electronic devices, such as between a smartphone and a laptop computer. The processing unit communicates with the internal rechargeable battery 114, 214 to determine how much capacity is remaining in the battery 114, 214. Upon determining the capacity level, the processing unit can communicate with the power indicator means 140, 240, 340 to provide the user with information for how much capacity is remaining in the internal rechargeable battery 114, 214 and whether the power strip 100, 200, 300 needs to be connected to an external power source for recharging. Further discussion of the power strip 100, 200, 300 charging capabilities is provided with regards to FIG. 8.

Additionally, in some embodiments, the processing unit communicates with a rechargeable battery of an electronic device attached to the power strip 100, 200, 300 to determine how much capacity is remaining in the rechargeable battery of the electronic device. Upon determining the capacity level of the electronic device, the processing unit can communicate with another power indicator means 140, 240, 340 to provide the user with information regarding the remaining capacity of the electronic device.

Referring to FIG. 8, the power strip 100, 200, 300 generally can detect the charge level of a connected electronic device and, based on the detected level, provide four zones, or states, of charging capability—namely, pre-charge, cc fast charge, cv taper, and done. Such states can be displayed by the power indicator means 140, 240, 340, or additional power indicator means, provided on the housing 112, 212, 312. The power strip 100, 200, 300 has the following functionality, described below, performed in conjunction with the controller and processing unit, to provide various connected electronic devices with charge.

The portable power strip 100, 200, 300 determines the charge level of a connected electronic device and, when the electronic device voltage is below a preset level, e.g., VLOW, charges the electronic device at a pre-charge current, e.g., I(PRECHG). Once the charging electronic device reaches the predetermined VLOWV level, the portable power strip 100, 200, 300 provides a predetermined fast charge, e.g., Io(CHG), constant current. Subsequently, the charge of the electronic device increases until it reaches a full charge VBAT(REG). As the power strip 100, 200, 300 detects that the electronic device is reaching a full charge, the power strip 100, 200, 300 charge current begins to taper off. When the charge current provided by the power strip 100, 200, 300 reaches a predetermined level, e.g., I(TERM), the charge current terminates.

Additionally, the portable power strip 100, 200, 300 can provide automatic recharging. For example, when battery voltage of a charged connected electronic device falls below a preset threshold, e.g., VRECHG (not shown), for example, while using a lap-top computer connected to the portable power strip 100, 200, 300, the power strip 100, 200, 300 can initiate charging.

Additionally, the portable power strip 100, 200, 300 can monitor the amount of time it is in the pre-charge state. After a set period of time, if the battery of a connected electronic device fails to rise above VLOWV, then the portable power strip 100, 200, 300 can terminate charging.

Additionally, the portable power strip 100, 200, 300 can monitor the amount of time it is in the cc fast charge state, and terminate charging if it remains in the cc fast charge state for too long.

To provide safety and longevity to the rechargeable internal battery 114, 214 and battery cells 144, 244, the portable power strip 100, 200, 300, can further provide: overcharge protection, by preventing charging above a specific preset voltage level; over discharge protection, by preventing discharge below a preset voltage level; short circuit protection, by disabling the power strip 100, 200, 300 when positive and negative connections are shorted together; and over current protection, by a separate circuit to shut off current when the power strip 100, 200, 300 is in an over discharge current condition.

Additionally, the portable power strip 100, 200, 300 can monitor the temperature of the internal rechargeable battery 114, 214 and terminate charging if the internal rechargeable battery 114, 214 or battery cells 144, 244 fall outside a specified temperature.

Additionally, when the power strip 100, 200, 300 is connected to an external power source and at least one electronic device, the power strip 100 can provide surge protection to the connected electronic device, whether the connected electronic device is connected to a DC connection port 118, 218, 318 or an AC socket 134, 234, 334.

Such surge protection is provided by a surge protection circuit including, for example, AC power lines (L), AC neutral (N) and ground (PE) conductors in connection with various metal oxide varistors, transient voltage suppressors, diodes, thyristors, gas discharge tubes and the like, to protect circuitry of the connected devices by either blocking, suppressing, or shorting to ground any unwanted voltages above a predetermined and set threshold.

When a surge occurs, the surge is inputted into the power strip 100, 200, 300 through the AC wall plug interface 130. After the surge, the surge protection circuit suppresses the surge, preferably in multiple stages, and the electricity can be transmitted to the DC connection ports 118, 218, 318 or AC plug sockets 134, 234, 334, as needed.

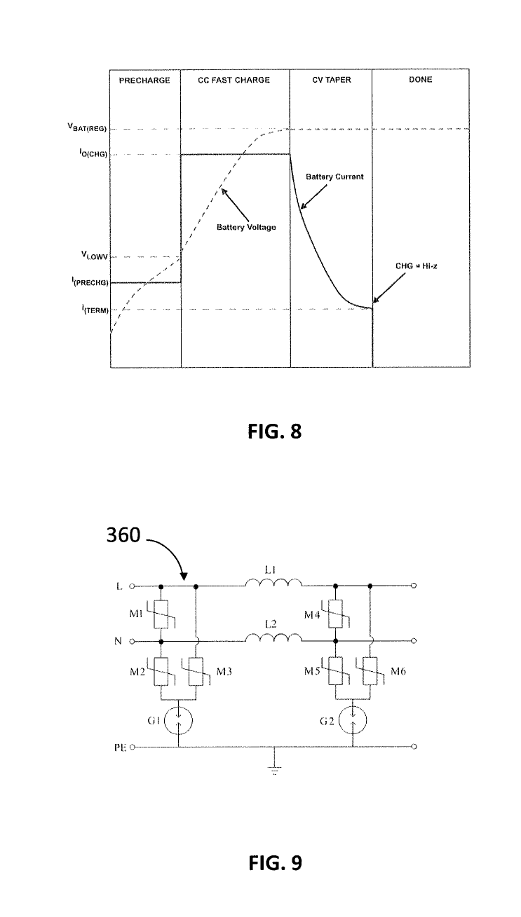

Referring to FIG. 9, an exemplary surge protection circuit 360 is illustrated. The surge protection circuit 360 provides surge protection for both common mode surge—namely, surge appearing equally on all conductors of a group at a given location—and differential mode surge—namely, surge occurring between any two conductors or two groups of conductors at a given location—in two stages. However, various arrangements and stages can also be used without departing from the spirit and principles of the present invention. As illustrated, metal oxide varistors M1-M6 and gas discharge tubes G1 and G2 are used in the first stage. In the first stage, M1 provides overvoltage limiting when in differential mode, while M2-G1 and M3-G1 provide overvoltage limiting for the common mode. In the second stage M4 provides overvoltage limiting for differential mode, while M5-G2 and M6-G2 provide overvoltage limiting for common mode. L1 and L2 are decoupling inductors that are used to coordinate the protective characteristics between the two stages.

The surge protection circuit 360 further includes a buffer conductive device for providing a buffer conductive path for delaying the duration of transferring the surge. In an embodiment the buffer conductive device is a wound conductive wire.

Multiple surge protection circuits are also contemplated within the scope of the current disclosure.

The foregoing description of embodiments of the present invention has been presented for the purpose of illustration and description. It is not intended to be exhaustive or to limit the invention to the form disclosed. Obvious modifications and variations are possible in light of the above disclosure. The embodiments described were chosen to best illustrate the principles of the invention and practical applications thereof to enable one of ordinary skill in the art to utilize the invention in various embodiments and with various modifications as suited to the particular use contemplated.

What is claimed is:

1. A portable power strip for recharging at least one electronic device having a rechargeable internal battery, the portable power strip comprising:
a housing internally storing a rechargeable battery;
a power input port formed in the housing and operatively connected to the rechargeable battery;
a detachable power cord for providing an electrical charge from an external power source to the power strip via the power input port; and
a plurality of power connection ports in operative communication with the internal battery and the power input port for providing an electrical charge to respective electronic devices from either the internal battery or the external power source when the devices are connected to the power strip via the power connection ports; and
a surge protection circuit for suppressing a surge and protecting respective electronic devices.

2. The portable power strip according to claim 1, further comprising a first indicator light extending around a perimeter of the housing for indicating power interruptions from the external power source to the power strip.

3. The portable power strip according to claim 1, wherein the power input connection port includes at least one prong extending therefrom for establishing an electrical connection with a proximal end of the power cord.

4. The portable power strip according to claim 1, wherein the plurality of power connection ports includes a DC connection port and an AC plug socket.

5. The portable power strip according to claim 4, further comprising a second indicator light extending around the perimeter of the AC plug socket.

6. The portable power strip according to claim 4, wherein the DC connection port is a power connection port that can operate as either a power input for providing an electrical charge from an external power source for recharging the rechargeable battery when the power strip is connected to the external power source or a power output for charging the rechargeable internal battery of the at least one electronic device from the rechargeable battery of the power strip.

7. The portable power strip according to claim 1, wherein the portable power strip automatically turns on and provides power when the at least one electronic device is connected to the power strip, and turns off when the at least one electronic device is fully charged.

8. The portable power strip according to claim 1, wherein the portable power strip automatically turns off after the at least one electronic device is unplugged from the power strip and after a defined delay period.

9. A portable power strip for recharging at least one electronic device having a rechargeable internal battery, the portable power strip comprising:
a housing internally storing a rechargeable battery;
a power input port formed in the housing and operatively connected to the rechargeable battery;
a detachable power cord for providing an electrical charge from an external power source to the power strip via the power input port;
a power indicator means for indicating the power level of the internal battery;
a plurality of power output connection ports in operative communication with the internal battery and the power input port for providing an electrical charge to respective electronic devices from either the internal battery or the external power source when the devices are connected to the power strip via the power output connection ports; and
a multi-stage surge protection circuit for suppressing a surge and protecting respective electronic devices;
wherein the plurality of power output connection ports include a DC connection port and an AC plug socket, and
whereby the power strip automatically switches into a portable operation mode when no charge is being supplied via the power input port.

10. The portable power strip according to claim 9, wherein the rechargeable battery of the portable power strip comprises at least two rows of 3000 mAh battery cells stored within the housing.

11. The portable power strip according to claim 9, wherein the DC connection port is disposed perpendicular to a length-wise direction of the housing.

12. The portable power strip according to claim 9, wherein the AC plug socket is disposed on a side face of the housing and the DC connection port is disposed on an end face of the housing.

13. The portable power strip according to claim 9, wherein the AC plug socket is rotatable.

14. The portable power strip according to claim 9, further comprising a keyhole-mounting slot disposed on a side face of the housing for mounting the power strip to a wall.

15. The portable power strip according to claim 9, further comprising anti-skid feet disposed on a bottom surface of the housing.

16. A portable power strip for recharging at least one electronic device having a rechargeable internal battery, the portable power strip comprising:
a housing internally storing a rechargeable battery;
a power input connection port formed in the housing and operatively connected to the rechargeable battery;
a detachable power cord for providing an electrical charge from an external power source to the power strip via the power input connection port;
a USB output connection port operatively connected to the internal battery for providing an electrical charge from the internal battery to respective electronic devices when the devices are connected to the USB output connection port; and
an AC plug socket operatively connected to the internal battery for providing an electrical charge from the internal battery to respective electronic devices when the devices are connected to the AC plug socket;
wherein the portable power strip can provide surge protection to the at least one electronic device connected at the USB output connection port.

17. The portable power strip according to claim 16, wherein the power input connection port is a clover shape having one or more prongs extending therefrom.

18. The portable power strip according to claim 16, wherein the housing includes a decorative skin obfuscating and camouflaging the USB output connection port.

19. The portable power strip according to claim 16, wherein the wherein the AC plug socket is rotatable.

20. The portable power strip according to claim 16, wherein the portable power strip can provide surge protection to the at least one electronic device connected at the AC plug socket.
